(19) United States
(12) Patent Application Publication
(10) Pub. No.: US 2011/0300879 A1
(43) Pub. Date: Dec. 8, 2011

(54) UNIVERSAL COMMUNICATION SYSTEM WITH SPECIAL APPLICATIONS

(76) Inventor: Günter Braun, Oberhaching (DE)

(21) Appl. No.: 13/201,464

(22) PCT Filed: Feb. 12, 2010
(86) PCT No.: PCT/IB2010/050653

§ 371 Date: Aug. 15, 2011

(30) Foreign Application Priority Data
Feb. 13, 2009 (DE) 102009008822.9

(51) Int. Cl. H04W 64/00

(52) U.S. Cl. 455/456.1

(57) ABSTRACT

The application provides a universal communication system. The communication system comprises
at least one base station that is communicatively connected to at least two terminal devices that comprise a radio communication module for communicating in a license-free, mostly local voice and/or data network such as DECT, WLAN, and others with the at least one base station, at least one of the terminal device comprising a cellular radio communication module and
a register for storing various phone numbers and possibly IP addresses of the terminal devices allocated to different communication networks, location information of the terminal devices if equipped with a positioning system, as well as rules and criteria for operating the terminal devices and/or the whole system.

This application relates to a communication system with mobile terminals that can be part of a virtual or of a real communication switching system but can also operate autonomously in various mobile networks via multiple protocols based on rules and criteria that can be defined individually.

Various applications, such as DE 102004058576, US 2002/0147008 A1, US 2005/0190747 A1, and WO 2007/059722, show mobile communication devices that can communicate over various radio systems, for example DECT (Digital Enhanced Cordless Telecommunications) system, WLAN (Wireless Local Area Network) system, or GSM (Global System for Mobile communications) system.

DE 102004058576 provides an optimized connection via a landline or various radio networks for an application of a stationary user with an aid of a universal adaptive interface unit. It enables a wireless connection additionally to an existing wired connection. The connection can be used for devices, such as analog or digital phones, fax machines, answering machines, or computers.

US 2002/0147008 A1 describes a method for transiting seamlessly from GSM telephony to Wi-Fi telephony.

US 2005/0190747 A1 describes a mobile phone for connecting to multiple networks that includes a cellular module for routing calls through a cellular telephone network and a wireless network module for routing calls on a wireless local area network (WLAN). The mobile telephone provides simultaneous connectivity to the cellular network and to the WLAN. The mobile phone enables a user to select a desired network access manually if both networks are present. This also applies to a foreign WLAN as well as to a possible home WLAN.

WO 2007/059722 describes a DECT phone with a base station and a handset. The DECT phone is equipped with a DECT module as well as a GSM module. If the handset leaves the range of the DECT base station, the base station switches to call-forwarding to the GSM module. Conversely, if the handset enters the range of the DECT base station, the base station switches call forwarding from the GSM module to the DECT module. One DECT module cooperates with one GSM module and with the local base station.

It is an objective of this application to provide a universal communication network system and a method of operating the universal communication network system.

The application provides a Universal Communication System. The system comprises
one or more base stations that are communicatively connected to two or more terminal devices or handsets that comprise a radio communication module for communicating in a license-free, mostly local voice and/or data network, such as DECT, WLAN, and others, with the base stations,
a cellular radio communication module in one or more terminal devices, and
a register for storing various internal and external phone numbers and possibly Internet Protocol (IP) addresses of the terminal devices allocated to different communication networks, location information of the terminal devices if equipped with a positioning system, as well as rules and criteria for operating the terminal devices and/or the whole system.

One or more of the terminals can include an emergency call device that comprises
a cellular radio communication module,
a communication module for communicating in a license-free, mostly local voice and/or data network such as DECT, WLAN, and others, and
an outdoor position determination means.

The emergency call device or any other terminal device can comprise an indoor position determination means. The emergency call device or any other terminal device can further comprise a VoIP (Voice over Internet Protocol) communication module and/or the emergency call device or any other terminal device that further comprises a satellite communications module or module extension.

The application provides a method for operating an emergency call device in a Communication System including the above system.

The method is characterized in that
the emergency call device is directly or indirectly communicatively connected to an emergency or medical call center using either a cellular radio communication module, a satellite communications module, or a communications module for a license-free, mostly local voice and/or data network such as DECT, WLAN, and others, depending on network availability and operating rules laid down in the register and a partial copy of the register stored in the memory of the emergency call device,
the emergency call device sends an alarm message or equivalent data and an information on the position of the emergency call device to an emergency call center, which in turn establishes a voice channel to contact the emergency call device primarily using the same communications network or method and the telephone number or IP address of the emergency call device that sent the information, or
the emergency call device only transmits its position at predetermined times or time intervals using information stored in the register or the memory of the device.

The position information of the emergency call device in case of operation in a license-free, mostly local voice and/or data network such as DECT, WLAN, and others can be assumed to be equivalent to the position of the base station which is stored in the register, or the position information can be obtained by an indoor or outdoor position determination means.

The emergency telephone call can have priority over other telephone calls of the base station
which leads to the termination or cut-off of a communication in an occupied channel in the license-free, mostly local voice and/or data network such as DECT, WLAN, and others if all channels are occupied and no other method of communication is available, or the operation rules laid down in the register require that action and
which following the outgoing emergency call, leads to the immediate reservation of a channel for the expected call of the emergency call center.

The application provides a method of operating the above universal communication system.

Each of the terminal devices has been allocated various phone numbers and possibly an IP address, each of which is used in a specific communication network, and is stored in the register as well as the memory of the device.

Each of the terminal devices has been allocated a short number within the license-free, mostly local voice and/or data network such as DECT, WLAN, and others, which can be trans-lated in any other number using the stored table within the register and the device memory.

Internal calls can be achieved dialing only the short number no matter which communication network the called device is operating in, while the system automatically routes the call to the recipient using the telephone number of the communication network where the recipient can be reached. All information to achieve this method of operation is stored in the register.

The terminals can leave the range of the license-free, mostly local voice and/or data radio network such as DECT, WLAN, and others, will automatically book themselves into a cellular network or other networks according to the given rules and their configuration, and send their new availability information to the register,
those terminals can be reached via call forwarding of incoming calls, and for outgoing calls can directly connect to the recipient of the call,
when coming back into the range of the license-free, mostly local voice and/or data radio network such as DECT, WLAN, and others, leave the cellular network while existing calls via the cellular network can be continued as long as required, and/or
all calls of each terminal can be billed to one telephone number.

The terminal can be equipped for VoIP over WLAN/WiFi can check out suitable available connections and can suggest an alternative communication method to the user. If accepted, the terminal changes its method of communication and tells the register its new connectivity and address. When leaving the WLAN/WiFi hotspot or triggered manually, the terminal changes back to its previous communication network or the one predetermined by its rules, and provides that information to the register.

In summary, the present application relates to a method of universal communication for mobile terminal devices. On one hand the mobile terminal devices are part of a virtual or a real communication system that has different types of network access while on the other hand the mobile terminal devices are often capable of establishing independently and automatically a best possible connection with the different types of wireless or mobile network access. The network access is established according to certain adjustable rules and to certain criteria. The mobile terminal devices are also able to communicate with each other in an independent manner.

The communication system can include a virtual communication system and/or a real communication system.

The virtual communication system is to be understood as a switching system for voice, data, or multimedia signals located within public networks. The virtual communication system can, for example, operate within a Public Switched Telephone Network (PSTN), a public data network, or can be a Central Exchange (Centrex) type installation

In contrast, the real communication system uses a dedicated switching system on a personal or company server or device. The real communication system can be based on a Digital Enhanced Cordless Telecommunications (DECT) system, a Wireless Local Area Network (WLAN) system, or other license-free cordless technology that includes, or that can in turn be linked to, a personal or a company switching system.

Besides being connected to a wireless or a cordless base station, the mobile terminal devices of communication system can communicate through various external radio communication networks, such as for example a Global System for Mobile communications (GSM) network, WLAN hotspots, a WiFi network, or satellite communications.

The mobile terminal devices may also include mobile emergency calling devices. The mobile emergency calling devices pose special demands with respect to functional reliability.

The application focuses on the virtual or the real communication system with more than one terminal device, wherein some of the terminal devices may also be connected via a cable. Furthermore, the mobile terminal devices may be equipped with means to determine their position.

Apart from enabling a universal type of communication that has a high or at least an acceptable quality, the universal communication system described in this application can also satisfy other demands. The demands can include ease of use, clear and accurate accounting of various network connections with just one accounting bill or record, a prioritization of emergency calls and associated positioning information, as well as compliance with relevant regulatory requirements.

Furthermore, the application enables a usage of only one telephone number per mobile terminal device to access all services for ease of use and for transparent accounting whilst internally different telephone numbers may be allocated to the mobile terminals for the various services.

Registers in the base station, the mobile terminal devices, and, for example, communication servers or switches provide information to the communication system that enables automatically optimized operation with only one visible telephone number across various mobile or cordless networks.

In the following examples of use, the DECT protocol serves as an example for various designated license-free wireless communication systems that may also operate in other frequency ranges or that may also use other technologies, such as Voice over IP (VoIP) over WLAN. The GSM protocol serves as an example for other types of license-based cellular networks and can also include satellite communications. The term fixed public network or fixed voice and data network serves as an example for all public or private communication networks that are fully or partly stationary and may, for example, include cable, radio relay, or satellite technologies.

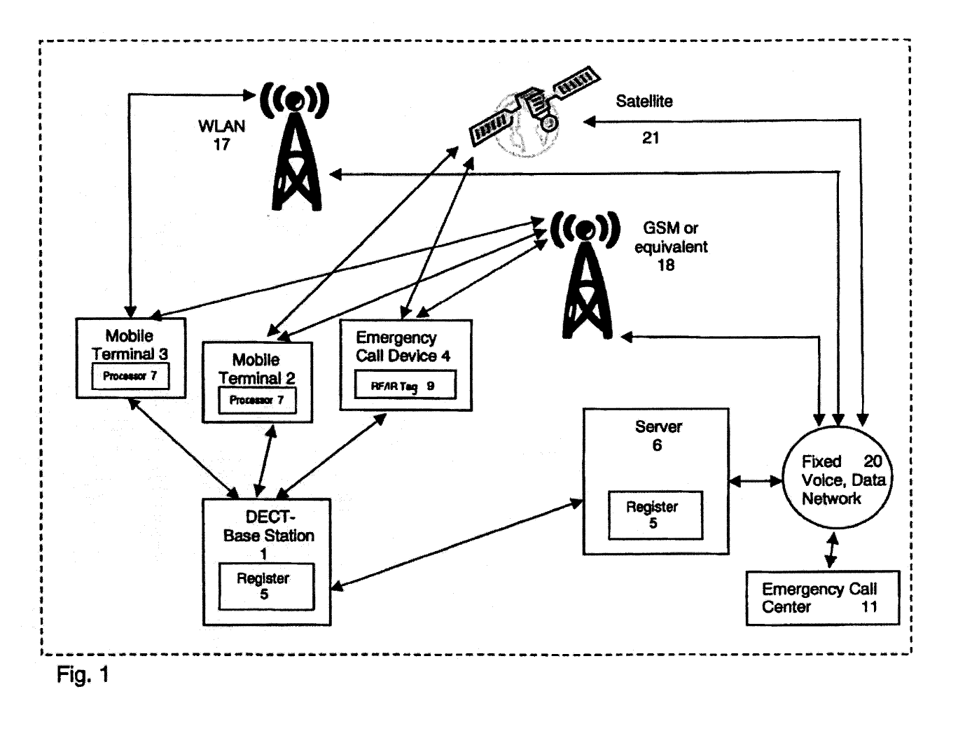

FIG. 1 illustrates an embodiment of a communication system that comprises a plurality of mobile terminal devices and an emergency terminal device, the mobile terminal devices and the emergency terminal device support WLAN and GSM protocol communications and may also include positioning technologies,

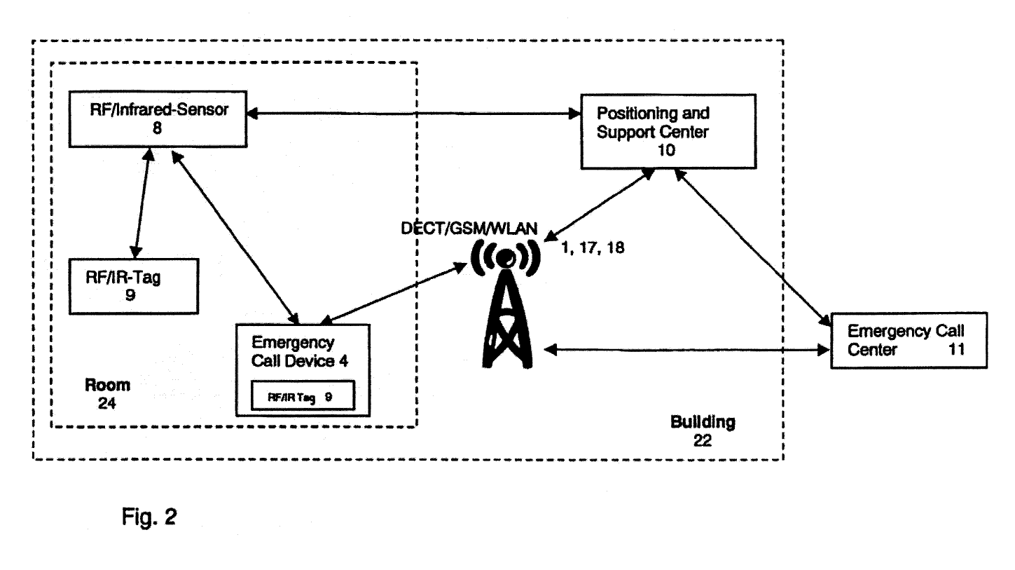

FIG. 2 illustrates a further embodiment of the communication system of FIG. 1, the further embodiment shows an autonomous usage of the emergency terminal device within buildings and shows possibilities to provide positioning information without access to navigation satellite systems, such as Global Positioning System (GPS), and

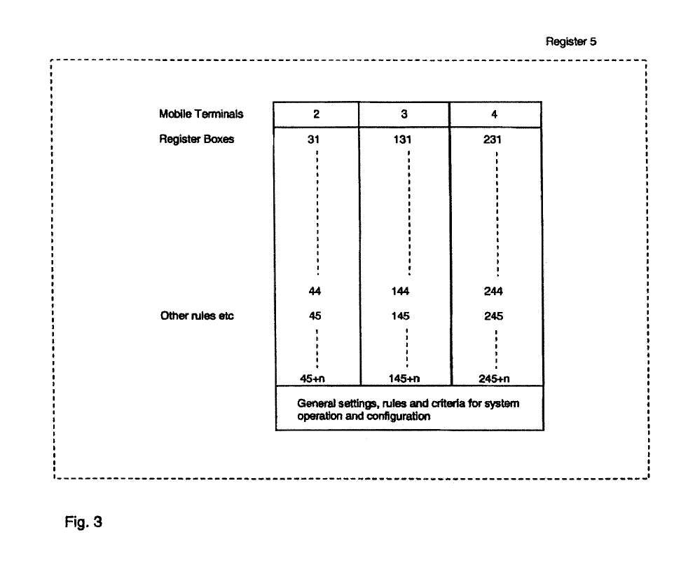

FIG. 3 illustrates contents of a register as well as a part of the register contents that is stored in a memory of any of the mobile terminal devices.

FIGS. 1 to 3 have similar parts. The similar parts have the same reference number or the same name. The description of the similar part is thus incorporated by reference.

FIG. 1: Network Configuration (Example)

FIG. 1 depicts an embodiment of a universal communication system with special applications 15 that comprises a DECT (Digital Enhanced Cordless Telecommunications) base station 1 that is communicatively connected to the mobile terminal devices 2 and 3 as well as to the emergency terminal device 4. The emergency terminal device 4 is also called an emergency calling device or an emergency call device. All terminals connected to the DECT base station 1 have individual telephone numbers and also be reached by the main number allocated to the DECT base station or a larger private communication network controlled by the server 6, and an individual extension number. There is also the possibility to direct an incoming call to a group of terminals (broadcast mode) as defined in the register 5 either in the server 6 or in the DECT base station 1.

The devices 2, 3, and 4 include GSM technology and can therefore communicate in a cellular network denominated by the base station 18. Moreover, each of the terminal devices 2, 3, and 4 comprises a module to support DECT protocol for communicating with the DECT base station 1 and a module to support GSM protocol for communicating with the GSM base station 18. The GSM module operates in cooperation with a SIM (Subscriber Identity Module card) from the contracted mobile network provider. Each SIM card contains a telephone number for the use of cellular networks.

Further, the mobile terminal device 3 includes a module to support VoIP (Voice over Internet Protocol) via WLAN protocol, and an IP address for communicating with the WLAN base station 17. For VoIP connection, a user can trigger the VOIP module of the terminal device 3 to check for availability of a suitable WLAN hotspot. The WLAN hotspot provides a wireless network access point to the Internet or other services. In certain situations, the VOIP module can suggest independently that the terminal device 3 accesses a particular WLAN hotspot.

On acceptance and on successful login to the WLAN hotspot, the terminal device 3 notifies the DECT base station 1 of its recent WLAN network access so that this can be recorded or updated in the register 5 of the DECT base station 1. Conversely, when the terminal device 3 is displaced or disconnected from the WLAN hotspot, the terminal device 3 switches back to GSM access and the terminal device 3 notifies the DECT base station 1 accordingly for recording onto the register 5 of the DECT base station 1.

The GSM module, the DECT module, and the VOIP module are not shown in the FIG. 1. The VoIP module provides another means of communication.

The mobile terminal device 2 is additionally able to communicate via satellite 21, and has an individual telephone number allocated to that service. Also in this case, the satcom module is not explicitly shown in the figure.

The DECT base station 1 is communicatively connected to a server 6 that is communicatively connected to a e.g. public fixed voice and data network 20. An emergency call center 11 is also communicatively connected to a fixed voice and data network 20. The WLAN base station 17 and the GSM base station 18 are also connected to the fixed voice and data network 20.

Each of the mobile terminal devices 2 and 3 comprises a processor 7 with integrated memory that includes a small register, whilst the DECT base station 1 includes a register 5. The server 6 includes also a register 5. Two different system configurations are thus supported:
Embodiments of the universal communication system may include the server 6 with its register, e.g. as a switching device for a private network. In that case, the mobile terminals 2, 3, and 4 are part of a larger private communication network that may comprise more than one DECT base station and additionally other communication devices. In this implementation, the register 5 will be optimally placed in the server 6.
In another embodiment of the universal communication system, the DECT base station 1 can directly be connected to the fixed network 20. In that case, there will be no server 6 and the register 5 in the DECT base station 1 will be used.

FIG. 2: Indoor and Outdoor Positioning

The terminal devices 2, 3, and 4 can also include positioning devices for outdoor use. The position devices include GPS (Global Positioning System) or equivalent receivers for determining positions or locations of the mobile terminal, mostly using satellite but in some cases also terrestrial differential GPS signals. The positioning devices are not separately shown in FIG. 1.

FIG. 2 shows an embodiment of the communication system 15 of FIG. 1 extended by an accurate indoor positioning system, also named as real-time locating system (RTLS). The embodiment depicts a system for determining indoor positions of the emergency calling device 4 using a sensor 8 that operates in cooperation with an RF/IR tag 9. All mobile terminal devices 2, 3, and 4 can include positioning devices for indoor use. In FIG. 2 this is shown for the emergency call device 4.

FIG. 2 depicts a building 22 that includes a room 24. The emergency terminal device 4 of the FIG. 1 is located in the room 24. The emergency terminal device 4 via its built-in RF/IR tag 9 is communicatively connected to a RF/IR sensor 8 that is communicatively connected to a location determination (positioning) and support center 10. The sensor 8 and an additional RF/tag 9 are located in the room 24.

The indoor position can be determined accurately if the emergency call device 4 is a outfitted with an RF/IR (radio frequency/infrared) tag 9 similar to the stand-alone RF/IR tag 9 that is communicating with RF/IR sensors 8 in any room 24 of the building 22. The sensor 8 and the tag 9 communicate with each other using RF (Radio Frequency) signals, IR (infrared) signals, or ultrasound signals. The RF/IR tag 9 provides an identifier for the sensor 8. The position of the sensor 8 is known to the positioning and support center 10. Further, the emergency call center 11 is communicatively connected to the positioning and support center 10 in the Internet. Instead of infrared, ultrasound technology can be employed.

This method allows a position of a caller of the emergency calling device 4 within a building 22, which can be a hospital or a nursing home or any other public or private building, to be determined.

The position of persons that carry the emergency call device 4 with integrated RF/IR tag 9 or of things that carry the stand-alone RF/RR tag 9 can be determined in a seamless manner. If the emergency call device 4 is outside the building 22, its position is determined or derived using satellite navigation. When the emergency call device 4 is inside the building 22, the position of the emergency call device 4 is determined via the positioning system of the building 22 that includes the RF/IR sensor 8 and the RF/IR tag 9. The determined position is sent to the positioning and support center 10 and, if required, to the emergency call center 11.

In this way, especially old, severely ill, or disoriented people can receive rapid help in an emergency. These people can be located indoor, such as hospitals and nursing homes, or they can be located outdoors.

Additionally, based on state-of-the-art technologies, the allocation of the mobile terminal to a DECT base station 1 or WLAN base station 17 or to several DECT or WLAN base stations in a private communication network can be used if only coarse accuracy is required for the position of the emergency call device. The emergency terminal device 4 is communicatively connected to the DECT base station 1, whose location is transmitted to the positioning and support center 10 and, if required, to the emergency call center 11. In a generic sense, the DECT base station 1 can be replaced by the WLAN base station 17 of FIG. 1.

FIG. 3: Register 5

The register 5 contains all individual telephone numbers of the mobile terminals either allocated to the DECT base station 1 or allocated to the server 6 if a larger communication system beyond the DECT base station 1 is concerned. For example, the following data per terminal 2, 3, and 4 is contained in the register, where the numbers relate to FIG. 3 in the way that the figures below relate to terminal 2, while the same information for terminal 3 is stored in the register boxes 131 to 144 and for terminal 4 in the register boxes 231 to 244:
31 Complete landline telephone number (a) and extension (b) allocated within the fixed network via the DECT base station 1 or the server 6, and
32 actual availability of that connection.
33 Telephone number of the SIM card for GSM use, and
34 actual availability of that connection.
35 IP address of the module for WLAN use, and
36 actual availability of that connection.
37 Telephone number of the module for satellite communication, and
38 actual availability of that connection.
39 Denomination if the terminal is an emergency call device.
40 Denomination if the terminal is equipped with a positioning module given for outdoor and/or indoor use
41 Number and position of the DECT base station 1.
42 Last position determined by a positioning device within the mobile terminal.
43 Priority allocation that is which connection is preferred in case of reasonable transmission quality, which is second, third etc, for example, depending on connection fees.
44 Defined minimum quality of a preferred connection

Further information related to operational and customerrelated requirements such as switching and communication rules are also stored in the register 5 with the same methodology.

The actual data of a mobile terminal stored in the register 5 is also available in the memory of the mobile device itself. Furthermore, configuration information for each mobile terminal can be stored in the register of the mobile device. It is not required to be stored in register 5, however, could still be stored there due to redundancy reasons. That is particularly important for emergency call devices.

### Examples for Communication and Locating Procedures and Methodology

Positioning

As long as any mobile terminal device and in particular the emergency call device 4 is in radio communications range of the DECT base station 1, or another DECT or WLAN base station within the local communications network controlled by the server 6, a GPS or other satellite receiver for positioning will in the standard configuration be switched off to save power. The position of the mobile terminal device is in a vicinity of the DECT base station 1. If the building has several DECT base stations, different positions or locations within the building can be determined. If a greater resolution of terminal device positions within a building is required, other methods can be employed.

For a more accurate positioning within buildings, the built in RF/IR tag of the mobile terminal device 4 is in operation provided the building is equipped with RF/IR sensors 8 which detect individual RF/IR-tags 9 or the same type of tags integrated in the emergency call device 4. The result is processed and shown on a floor plan by the positioning and support center 10 in the Internet using a web browser. The emergency data center or e.g. staff of a hospital or elderly people's or nursing homes is authorized to view the position of the persons they are responsible for.

When the emergency call device leaves the range of DECT connectivity, the global outdoor positioning system is switched on according to a predefined operation mode that can be remotely changed, and will take into account power saving. It uses the position of the DECT base station 1 to determine its initial outdoor position.

The emergency call center can retrieve the position data provided by the emergency call device 4 in case of an emergency call via the positioning and support center 10 in the Internet using a web browser. Other modes of operation can be remotely configured by the service provider.

A smooth or seamless generation of positioning data for an indoor situation and for an outdoor situation is provided for the terminal devices 2, 3, and 4 if they are equipped accordingly.

In particular, the emergency calling device 4 transmits regularly its position data according to its setting or its system configuration to the register 5 of the server 6 or to the register 5 of the DECT base station 1. The position data of emergency calling device 4 is also transmitted to the positioning and support center 10 when a user makes a call using the emergency calling device 4.

Incoming Call, Cordless Operation of Terminal

During operation, the mobile terminal devices 2, 3, and 4 can operate in a cordless phone mode (DECT and other license-free networks) or in a cellular phone mode (GSM and other licensed mobile networks including satellite).

For operating in the cordless phone mode, each of the mobile terminal devices 2, 3, and 4 uses its individual landline telephone number or extension to receive cordless phone calls. In the following description and examples, state-ofthe-art switching technology as used by the server 6 and the DECT base station 1 is well known and does not need to be described further. Any outside call directed e.g. to the mobile terminal 3 is either coming directly to the DECT base station 1 or in a larger private network coming to the server 6. In both cases, register 5 contains the information that the mobile terminal 3 is in radio communications range of the DECT base station 1. The DECT base station 1 initiates the call using the landline telephone number or the extension number of the mobile terminal device 3 operating in cordless mode.

Incoming Call, GSM Operation of Terminal

In case the mobile terminal device 3 is not in range of the cordless system with e.g. DECT base station 1, alternative communication media based on availability and predetermined rules stored in the register 5 of the DECT base station 1 or the server 6 are selected. E.g. if the next priority for the mobile terminal 3 in the register 5 is GSM, the availability of the mobile terminal 3 via GSM is checked out and the call is forwarded to the GSM-related telephone number of the mobile terminal 3. Similarly, the call can be forwarded through satellite. For the mobile terminal 2 which is equipped with a device for WLAN usage, the call can also be forwarded via a WLAN base station (e.g. hot spot) in range of the mobile terminal 2. All information for the call forwarding is contained in the register 5. Information on the availability of the mobile terminal in cordless mode is readily fed into the register 5 as long as the mobile terminal is in range. The availability of alternative modes of communication can either be fed into the register through the mobile network provider itself, through an information sent by the mobile terminal when it is booked into the GSM network, or checked out by trying to reach the mobile terminal in the network that has been allocated the next highest priority. The method selected will depend on cost and connecting speed, and is laid down in the rules stored in register 5.

Incoming Call, Broadcast Mode

Calling the main call number of the DECT base station 1, the broadcast mode is initiated. In a broadcast mode, the terminal devices 2, 3, and 4 can also receive the cordless phone calls via the DECT base station 1. However, in the broadcast mode, the first mobile terminal to accept the call is connected, the others are not. As it is well known, the call can still be forwarded internally to another mobile terminal. If no switched-on mobile terminal is in range of the DECT base station 1, a rule can be stored in register 5 that will direct the call to one defined terminal, to which it will then be forwarded using the procedure described in the last section.

Incoming or Outgoing Calls Via GSM Operation of Terminal Obviously, all mobile terminals can also directly be reached from external through their GSM number or satellite communications, provided they are not in an area or building without mobile radio reception. Internal calls between all mobile terminals can therefore also be done in GSM networks, and a rule may be laid down in the register 5 and the corresponding small registers in any mobile terminal device that direct GSM-GSM calls in the same provider's network could be preferred due to cost reasons.

This operation mode is further supported when the GSM or satellite telephone numbers or IP addresses of the mobile terminals allocated to the DECT base station 1 are also be stored in the memory of the mobile terminals (thus using a larger part of register 5 on board). However, in that case updates in one terminal device need to be transmitted and stored in all others of that group.

This GSM-GSM operating mode is of particular importance in case the emergency call device 4 has been used to send an emergency call or alarming vital data to an emergency call center or a telehealth call center in e.g. GSM mode or GPRS mode. In that case, the GSM-related telephone number and the position of the sender is transmitted, and the return call will be done in GSM mode as well. The same method applies if another mode of communication is used.

Outgoing Call, Cordless Operation of Terminal

Calls initiated by any of the mobile terminals 2, 3, and 4 in cordless mode go to the DECT base station 1 and are switched to their destinations in the ordinary way. However, if a call is initiated by the mobile emergency call device 4, while all the channels of the DECT system are occupied, one channel is immediately made available by the DECT base station. The emergency call device is tagged accordingly in the register 5 in register box 239 (see FIG. 3). Which one of the occupied channels is terminated first, can be laid down in the rules stored in register 5. Also, a channel for the expected call of the emergency call center is reserved. Alternatively, the emergency call device 4 can use the built-in GSM capability right away.

Internal Calls, Cordless—Cordless

Internal calls between e.g. mobile terminals in case of both terminals being in cordless mode, are done via switching by the DECT base station 1 as usual. Similarly, if the mobile terminal 2 calls and terminal 3 is in another cordless area of the private communication network, the call is directed based on the information in register 5 with regard to the availability of mobile terminal 3.

Internal Calls, Cordless—GSM or Else

If the mobile terminal 3 is not in the range of the DECT system but operates e.g. in GSM mode, there are two possibilities to route the call. The information on the availability is again contained in register 5 which also provides the GSM phone number of the mobile terminal 3. The call can then be routed via server 6 (if applicable) and the fixed network via GSM base station 18 to the GSM network into which the terminal 3 has been booked. Alternatively, the mobile terminal 2 switches into GSM mode once it has received the GSM phone number of terminal 3 and calls terminal 3 (GSM-GSM). Alternatively, as the GSM or satellite telephone numbers or IP addresses of the mobile terminals allocated to the DECT base station 1 can also be stored in the memory of the mobile terminals (thus using a larger part of register 5 on board), the call GSM-GSM can be initiated without the need to transmit the GSM phone number of terminal 3 first. However, in that case, an update of all mobile terminals allocated to the DECT base station 1 will be necessary with each change in another mobile terminal.

In addition, the terminal device 3 has an IP (Internet Protocol) address to transfer voice or data signals via the VIOP module. I.e. it can communicate via an available WLAN/Wi-Fi access. That communication mode can also be used according to the rules laid down in the register 5.

The methods to be selected will largely depend on the usage and the actual pricing of the calls. The calling terminal will usually transmit its allocated landline phone number but can just as well transmit its GSM number when operating in GSM mode—or its IP address and vice versa.

In all possible cases of operation, the billing information can be allocated to the landline or to another telephone number by GSM, WLAN/WiFi or satellite communication operators, so that the customer receives only one telephone bill.

Summary of Methodology

Put differently, the terminal devices 2, 3, and 4 can be reached via their individually assigned cellular call number, their individual landline number or via the main call number. The mobile terminal 2 can also be reached via satellite. The terminal device 3 can also be reached via the IP address. This provides different operation modes for the terminal devices 2, 3, and 4 and thereby allows the terminal devices 2, 3 and 4 to operate in a best or better possible communication mode. This is especially important to secure a maximum availability and reliability of the emergency call device. It improves the availability of the call receiver considerably. It will also minimize communication cost and the ease of use of the communication system as it uses the optimum communication method automatically, once it has stored a set of rules in the register 5 and the mobile terminals

Within an operating range of the DECT base station 1, the terminal devices 2, 3 and 4 operate in the cordless phone mode. If any of the terminal device 2, 3, or 4 moves outside of the operating DECT range, it switches automatically to the cellular mode. Correspondingly, the DECT base station 1 registers this and it forwards incoming calls for the affected terminal device 2, 3, or 4 to its respective mobile phone number.

The emergency call device 4 is intended for users that have movement or visual limitations. The emergency call device 4 allows the users to make an emergency call in an intuitive way. The emergency call has priority over normal DECT calls. This is provided by tagging the emergency call device in register 5 accordingly. Connection of the emergency call can be guaranteed or be assured in that an existing DECT communication channel connection is terminated or cut-off to immediately enable the emergency call, if all DECT communication channels are occupied and a GSM access is not possible.

The terminal calling device 4 has enhanced reliability as it can access the emergency call center 11 in more than one way. It can access the emergency call center 11 via the DECT base station 1 or via the GMS base station 18, if required also via satellite 21.

In a special embodiment, the emergency calling device 4 is used by children to connect them directly to their parents instead of an emergency call center. Further, the parents of these children can retrieve position data of the emergency call device 4 via the Internet using a web browser. The access to the positioning data is individually provided by the service provider using a password. Similarly, the device can be used to allow elderly persons suffering from dementia to move around the premises of an elderly people's home or nursing home instead of locking them in. The device can automatically send a notice to the nurses when the person moves outside a defined area (electronic fence). Also, the person can be found indoor when his availability is required by a doctor or other care givers.

In all possible cases of operation, the billing information can be allocated to the landline or another telephone number by GSM, WLAN/WiFi or satellite communication operators, so that the customer receives only one telephone bill.

### REFERENCE NUMBERS

1 DECT (Digital Enhanced Cordless Telecommunications) base station
2 mobile terminal device
3 mobile terminal device
4 emergency terminal device
5 register
6 server
7 processor
9 RF/IR tag
10 location determination and help centre
11 emergency call centre
15 communication system
17 WLAN base station
18 GSM base station
20 voice and data network
21 satellite
22 building
24 room

1. Universal Communication System comprising
at least one base station that is communicatively connected to at least two terminal devices or handsets that comprise a radio communication module for communicating in a license-free, mostly local voice and/or data network such as DECT, WLAN, and others with the at least one base station,
a cellular radio communication module in at least one of the terminal devices, and
a register for storing various internal and external phone numbers and possibly IP addresses of the terminal devices allocated to different communication networks, location information of the terminal devices if equipped with a positioning system, as well as rules and criteria for operating the terminal devices and/or the whole system.

2. Universal Communication System according to claim 1,
characterized in that
at least one of the terminals is an emergency call device that comprises
a cellular radio communication module,
a communication module for communicating in a license-free, mostly local voice and/or data network such as DECT, WLAN, and others, and
an outdoor position determination means.

3. Universal Communication System according to claim 2,
characterized in that
the emergency call device or any other terminal device comprises an indoor position determination means.

4. Universal Communication System according to claim 1,
characterized in that
the emergency call device or any other terminal device further comprises a VoIP (Voice over Internet Protocol) communication module and/or
the emergency call device or any other terminal device further comprises a satellite communications module or module extension

5. Method for operating an emergency call device in a Communication System including the system according to claim 1,
characterized in that
the emergency call device is directly or indirectly communicatively connected to an emergency or medical call center using either a cellular radio communication module, a satellite communications module, or a communications module for a license-free, mostly local voice and/or data network such as DECT, WLAN, and others, depending on network availability and operating rules laid down in the register and a partial copy of the register stored in the memory of the emergency call device,
the emergency call device sends an alarm message or equivalent data and an information on the position of the emergency call device to an emergency call center, which in turn establishes a voice channel to contact the emergency call device primarily using the same communications network or method and the telephone number or IP address of the emergency call device that sent the information, or
the emergency call device only transmits its position at predetermined times or time intervals using information stored in the register or the memory of the device.

6. Method according to claim 5,
characterized in that
the position information of the emergency call device in case of operation in a license-free, mostly local voice and/or data network such as DECT, WLAN, and others is assumed to be equivalent to the position of the base station which is stored in the register or
the position information can be obtained by an indoor or outdoor position determination means.

7. Method according to claim 5,
characterized in that
the emergency telephone call has priority over other telephone calls of the base station
which leads to the termination or cut-off of a communication in an occupied channel in the license-free, mostly local voice and/or data network such as DECT, WLAN, and others if all channels are occupied and no other method of communication is available, or the operation rules laid down in the register require that action and
which following the outgoing emergency call, leads to the immediate reservation of a channel for the expected call of the emergency call center.

8. Method of operating the universal communication system according to claim 1,
characterized in that
each of the terminal devices has been allocated various phone numbers and possibly an IP address, each of which is used in a specific communication network, and is stored in the register as well as the memory of the device,
each of the terminal devices has been allocated a short number within the license-free, mostly local voice and/or data network such as DECT, WLAN, and others, which can be translated in any other number using the stored table within the register and the device memory, and
internal calls can be achieved dialing only the short number no matter which communication network the called device is operating in, while the system automatically routes the call to the recipient using the telephone number of the communication network where the recipient can be reached. All information to achieve this method of operation is stored in the register.

9. Method of operating the universal communication system according to claim 1,
characterized in that
terminals which leave the range of the license-free, mostly local voice and/or data radio network such as DECT, WLAN, and others, will automatically book themselves into a cellular network or other networks according to the given rules and their configuration, and send their new availability information to the register,
those terminals can be reached via call forwarding of incoming calls, and for outgoing calls can directly connect to the recipient of the call,
when coming back into the range of the license-free, mostly local voice and/or data radio network such as DECT, WLAN, and others, leave the cellular network while existing calls via the cellular network can be continued as long as required, and
all calls of each terminal can be billed to one telephone number.

10. Method of operating the universal communication system according to claim 1,
characterized in that
a terminal equipped for VoIP over WLAN/WiFi can check out suitable available connections and suggest an alternative communication method to the user,
if accepted, the terminal changes its method of communication and tells the register its new connectivity and address, and
when leaving the WLAN/WiFi hotspot or triggered manually, the terminal changes back to its previous communication network or the one predetermined by its rules, and provides that information to the register.
